(19) United States
(12) Patent Application Publication
(10) Pub. No.: US 2013/0007010 A1
(43) Pub. Date: Jan. 3, 2013

(54) REQUIREMENTS EXTRACTION FROM EXTERNAL SOURCES FOR SOFTWARE LIFECYCLE MANAGEMENT

(75) Inventors: Michael E. Browne, Staatsburg, NY (US); Nnaemeka I. Emejulu, Austin, TX (US); Andrew J. Lavery, Austin, TX (US); Mario A. Maldari, Longmont, CO (US)

(73) Assignee: International Business Machines Corporation, Armonk, NY (US)

(21) Appl. No.: 13/171,318

(22) Filed: Jun. 28, 2011

(51) Int. Cl. G06F 17/30

(52) U.S. Cl. 707/748; 707/755; 707/E17.009

(57) ABSTRACT

Embodiments of the present invention provide a method, system and computer program product for software requirements extraction from external sources for software development. In an embodiment of the invention, a method for software requirements extraction from external sources for software development includes retrieving content from over a computer communications network pertaining to a product. The content can include by way of example, a Web page, e-mail message, instant message, blog posting or social network posting, to name only a few. Within the content, a modal verb can be identified and text extracted that is proximate to the modal verb. Thereafter, a requirement can be generated for a revision of the product based upon the extracted text. Optionally, the requirement can be ranked according to the modal verb, for example, an imperative modal verb can correspond to a higher ranking than a suggestive modal verb.

### BACKGROUND OF THE INVENTION

1. Field of the Invention

The present invention relates to software development lifecycle management and more particularly to requirements determination for new software releases during software development lifecycle management of computer software.

2. Description of the Related Art

A software development process, also known as a software development life cycle (SDLC), is a structure imposed on the development of a software product. Similar terms include software life cycle and software process. It is often considered a subset of systems development life cycle. There are several models for such processes, each describing approaches to a variety of tasks or activities that take place during the process. Common to all models, however, is the notion that the software development lifecycle begins with a requirements analysis as part of a planning phase, proceeds with design and implementation stages, continues through a verification stage, and culminates with a maintenance phase.

An important task in creating a software product is extracting the requirements or requirements analysis. Once the general requirements are gathered from the client, an analysis of the scope of the development can be determined and clearly stated within a scope document. The scope document, in turn, can be used as a framework for creating a design document known as a functional specification which in turn can be used in implementing the software product. Thus, a failure to properly ascertain the requirements of a computer program can taint the scope document and can be fatal to the software lifecycle as a whole.

Notwithstanding, it is well understood that determining software requirements is not without challenge. In this regard, the end user base typically enjoys only an abstract idea of what is desired in a computer program as an end result, but not what the computer program should actually do. Incomplete, ambiguous, or even contradictory requirements are recognized as typical by skilled and experienced software engineers. Yet, collective forums of end users often provide group think as to what the requirements of a computer program should be.

Specifically, just as is the case with any consumer product, end users often collaborate on line and share commentary regarding the critique of a commonly software product including recognized flaws and desired features. Journalists contribute to this collective body of knowledge by publishing journalistic reviews of computer programs. To translate requirements for a computer program revision from online sources, however, can be manually intensive requiring a scouring of online sources and note taking, and therefore, is not always realistic.

### BRIEF SUMMARY OF THE INVENTION

Embodiments of the present invention address deficiencies of the art in respect to requirements determination for software development and provide a novel and non-obvious method, system and computer program product for software requirements extraction from external sources for software development. In an embodiment of the invention, a method for software requirements extraction from external sources for software development includes retrieving content from over a computer communications network pertaining to a product. The content can include by way of example, a Web page, e-mail message, instant message, blog posting or social network posting, to name only a few. Within the content, a modal verb can be identified and text extracted that is proximate to the modal verb. Thereafter, a requirement can be generated for a revision of the product based upon the extracted text. Optionally, the requirement can be ranked according to the modal verb, for example, an imperative modal verb can correspond to a higher ranking than a suggestive modal verb.

In another embodiment of the invention, a software development data processing system can be configured for software requirements extraction from external sources. The system can include a host computer with at least one processor and memory and a content crawler executing in the host computer and configured to crawl content sources over a computer communications network to retrieve content pertinent to a software product. A requirements extraction module can be coupled to the content crawler. The module can include program code enabled upon execution in the host computer to identify a modal verb within content retrieved by the crawler, to extract from the content text that is proximate to the modal verb and to generate a requirement for a revision of the product based upon the extracted text.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for software requirements extraction from external sources for software development;

FIG. 2 is a schematic illustration of a software development data processing system configured for software requirements extraction from external sources; and,

FIG. 3 is a flow chart illustrating a process for software requirements extraction from external sources for software development.

### DETAILED DESCRIPTION OF THE INVENTION

Embodiments of the invention provide for software requirements extraction from external sources for software development. In accordance with an embodiment of an invention, one or more external content sources can be accessed and content parsed at those content sources for text proximate to a modal verb such as “must”, “should” “had better”, “have to” and “ought to”. The text proximate to a modal verb in turn can be processed, for example natural language processed, to determine its relevance to a software product subject to a software development lifecycle. Text determined to be relevant to the software product can be reported to the end user as a potential requirement for a next revision of the software product.

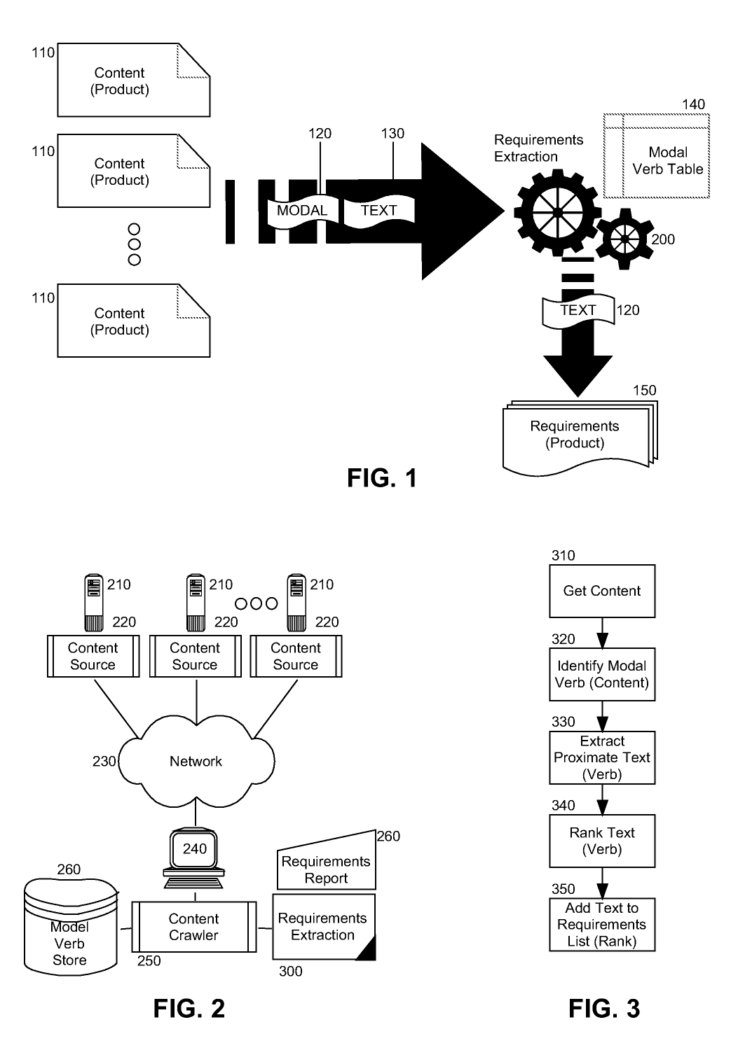

In further illustration, FIG. 1 pictorially shows a process for software requirements extraction from external sources for software development. As shown in FIG. 1, requirements extraction logic 200 can analyze external content 110 for different content sources, such as Web pages, blog postings, social network postings, electronic mail, instant messaging session logs and the like, to identify content 110 that references a particular product, such as a computer program. Modal verbs 120 within the content 110 set forth in a table 140 of modal verbs can be identified, such as the terms “must”, “should” “had better”, “have to” and “ought to”. Text 130 proximate to the modal verbs 120 can be extracted by the requirements extraction logic 200 and placed in a data store of requirements 150 for the product. Optionally, the requirements 150 can be ranked according to the nature of the modal verb 120 proximate to the text 130, with imperative modal verbs such as “must” and “have to” are ranked higher than suggestive modal verbs such as “should” and “ought to”. The text 130 further can be filtered from the requirements 150 through a natural language processing to ensure a relatedness between the text 130 and the product.

The process described in connection with FIG. 1 can be implemented in connection with a computer program product within a software development data processing system. In this regard, FIG. 2 is a schematic illustration of a software development data processing system configured for software requirements extraction from external sources. The system can include a host computer 240 with at least one processor and memory configured for communicative coupling over computer communications network 230 to different servers 210, each acting as a content source 220 of content, such as a Web site, blog, social network, e-mail server, chat server and the like.

The host computer 240 can support the execution in memory of a content crawler 250. The content crawler 250 can be configured to periodically crawl content from the content sources 220 to identify content pertinent to a software product. Requirements extraction module 300 can be coupled to the content crawler 250 and can include program code that when executed in the memory of the host computer 240 can identify text within the crawled content pertinent to the software product that is proximate to a modal verb. Text determined to be proximate to the modal verb (such as within zero or more words of the modal verb) can be extracted from the content by the requirements extraction module 300 and included in a requirements report 260.

In event yet further illustration of the operation of the program code of the requirements extraction module 300, FIG. 3 is a flow chart illustrating a process for software requirements extraction from external sources for software development. Beginning in block 310, content can be received and in block 320, a modal verb can be identified within the content. In block 330, text proximate to the modal verb can be extracted and ranked, in block 340, according to the type of modal verb. For instance, a table can be maintained associating each modal verb in the table with a corresponding ranking. Finally, in block 350 the extracted text can be included in a list of requirements which can be presented in the display of a computer according to rank.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for software requirements extraction from external sources for software development, the method comprising:
retrieving content from over a computer communications network pertaining to a product;
identifying a modal verb within the content;
extracting from the content text that is proximate to the modal verb; and,
generating a requirement for a revision of the product based upon the extracted text.

2. The method of claim 1, wherein the content is a Web page.

3. The method of claim 1, wherein the content is a blog posting.

4. The method of claim 1, wherein the content is a social network posting.

5. The method of claim 1, further comprising ranking the requirement according to the modal verb.

6. The method of claim 1, wherein imperative modal verbs correspond to a higher ranking than suggestive modal verbs.

7. A software development data processing system configured for software requirements extraction from external sources, the system comprising:
a host computer with at least one processor and memory;
a content crawler executing in the host computer and configured to crawl content sources over a computer communications network to retrieve content pertinent to a software product; and,
a requirements extraction module coupled to the content crawler, the module comprising program code enabled upon execution in the host computer to identify a modal verb within content retrieved by the crawler, to extract from the content text that is proximate to the modal verb and to generate a requirement for a revision of the product based upon the extracted text.

8. The system of claim 7, wherein the content is a Web page.

9. The system of claim 7, wherein the content is a blog posting.

10. The system of claim 7, wherein the content is a social network posting.

11. The system of claim 7, wherein the program code of the module is further enabled to rank the requirement according to the modal verb.

12. The system of claim 11, wherein imperative modal verbs correspond to a higher ranking than suggestive modal verbs.

13. A computer program product for software requirements extraction from external sources for software development, the computer program product comprising:
a computer readable storage medium having computer readable program code embodied therewith, the computer readable program code comprising:
computer readable program code for retrieving content from over a computer communications network pertaining to a product;
computer readable program code for identifying a modal verb within the content;
computer readable program code for extracting from the content text that is proximate to the modal verb; and,
computer readable program code for generating a requirement for a revision of the product based upon the extracted text.

14. The computer program product of claim 13, wherein the content is a Web page.

15. The computer program product of claim 13, wherein the content is a blog posting.

16. The computer program product of claim 13, wherein the content is a social network posting.

17. The computer program product of claim 13, further comprising computer readable program code for ranking the requirement according to the modal verb.

18. The computer program product of claim 17, wherein imperative modal verbs correspond to a higher ranking than suggestive modal verbs.
